(19) United States
(12) Patent Application Publication
(10) Pub. No.: US 2019/0073052 A1
(43) Pub. Date: Mar. 7, 2019

(54) TOUCH PANEL

(71) Applicants: Interface Technology (ChengDu) Co., Ltd., Sichuan (CN); Interface Optoelectronics (ShenZhen) Co., Ltd., Guangdong (CN); General Interface Solution Limited, Miaoli County (TW)

(72) Inventors: Chin-Yuan CHEN, Guangdong (CN); Ping-Yang CHEN, Guangdong (CN); Ying-Chieh CHIANG, Guangdong (CN); Tzu-Hsiang LIN, Guangdong (CN)

(21) Appl. No.: 15/784,183

(22) Filed: Oct. 15, 2017

(30) Foreign Application Priority Data
Sep. 1, 2017 (CN) 201710784755.9

(51) Int. Cl. G06F 3/044

(52) U.S. Cl. CPC G06F 3/044; G06F 2203/04111

(57) ABSTRACT

The disclosure provides a touch panel having a touch sensing region and a peripheral circuit region. The touch panel includes a transparent substrate, a touch sensing layer, a first fanout circuit, and a second fanout circuit. The touch sensing layer is located above the transparent substrate and is disposed in the touch sensing region, in which the touch sensing layer has plural sensing units. The first fanout circuit is disposed in the peripheral circuit region. The second fanout circuit is disposed in the peripheral circuit region and is located above the first fanout circuit. The first fanout circuit and the second fanout circuit are electrically connected to the sensing units respectively. A projection of the first fanout circuit on the transparent substrate and a projection of the second fanout circuit on the transparent substrate at least partially overlap each other.

### RELATED APPLICATIONS

This application claims priority to China Application Serial Number 201710784755.9, filed Sep. 1, 2017, which is herein incorporated by reference.

### BACKGROUND

### Field of Invention

The present invention relates to a touch panel. More particularly, the present invention relates to a touch panel having a first fanout circuit overlapping a second fanout circuit.

### Description of Related Art

With the development of the touch sensing technology, the quality of the touch device has been continuously improving. For a touch device, how to increase the available screen area is always an important issue in the industry. For example, smart phones with narrow border design have already become mainstream in the current market.

However, border widths are determined by the manufacturing process of conductive circuits, and the manufacturing process for the conductive circuits such as printing, laser, photolithography, and other processes have reached their limit on the line width of the conductive circuitry. So how to achieve an even more extremely narrow border under the limitations of aforementioned existing processes is an imperative problem to be solved in the industry.

### SUMMARY

The disclosure provides a touch panel having a touch sensing region and a peripheral circuit region. The touch panel includes a transparent substrate, a touch sensing layer, a first fanout circuit, and a second fanout circuit. The touch sensing layer is located above the transparent substrate and is disposed in the touch sensing region, in which the touch sensing layer has a plurality of sensing units. The first fanout circuit is disposed in the peripheral circuit region. The second fanout circuit is disposed in the peripheral circuit region and is located above the first fanout circuit, in which the first fanout circuit and the second fanout circuit are electrically connected to the sensing units respectively, in which a projection of the first fanout circuit on the transparent substrate and a projection of the second fanout circuit on the transparent substrate at least partially overlaps each other.

In some embodiments, the touch panel further includes a patterned insulating layer. The patterned insulating layer is located between the first fanout circuit and the second fanout circuit, in which the first fanout circuit and the second fanout circuit are electrically insulated from each other by the patterned insulating layer.

In some embodiments, the patterned insulating layer includes plural vias. The second fanout circuit is connected to the sensing units through a conductive material in some of the vias of the patterned insulating layer respectively, in which the conductive material and the first fanout circuit are made of a substantially similar material.

In some embodiments, the touch panel further includes at least a bridge structure. The bridge structure is connected between adjacent two of the sensing units, in which the at least one bridge structure includes an insulating bump and a connecting line.

In some embodiments, the connecting line crosses over the insulating bump and is electrically connected to the adjacent two of the sensing units.

In some embodiments, the connecting line is electrically connected to the adjacent two of the sensing units through at least an opening of the insulating bump.

In some embodiments, the patterned insulating layer and the insulating bump are made of a substantially similar material.

In some embodiments, the connecting line and the second fanout circuit are made of a substantially similar material.

In some embodiments, the first fanout circuit has a first widZith, the second fanout circuit has a second width, in which a projection of the first width of the first fanout circuit on the transparent substrate entirely overlaps a projection of the second width of the second fanout circuit on the transparent substrate.

In some embodiments, the first fanout circuit has a first width, the second fanout circuit has a second width, in which a projection of the first width of the first fanout circuit on the transparent substrate is partially shifted from a projection of the second width of the second fanout circuit on the transparent substrate.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1A illustrates a schematic top view of a touch panel according to an embodiment of the present disclosure;

FIG. 1B illustrates a cross-sectional view of the touch panel along a line 1B-1B shown in FIG. 1A;

FIG. 1C illustrates a cross-sectional view of the touch panel along a line 1C-1C shown in FIG. 1A;

FIG. 1D illustrates a cross-sectional view of the touch panel along a line 1D-1D shown in FIG. 1A;

FIG. 2 illustrates a schematic cross-sectional view of a touch panel according to an embodiment of the present disclosure;

FIG. 3A illustrates a schematic diagram of sensing units of a touch panel 300 according to another embodiment of the present disclosure;

FIG. 3B illustrates a cross-sectional view of a touch panel along a line 3B-3B shown in FIG. 3A; and

FIG. 3C illustrates a cross-sectional view of a peripheral circuit region of the touch panel.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

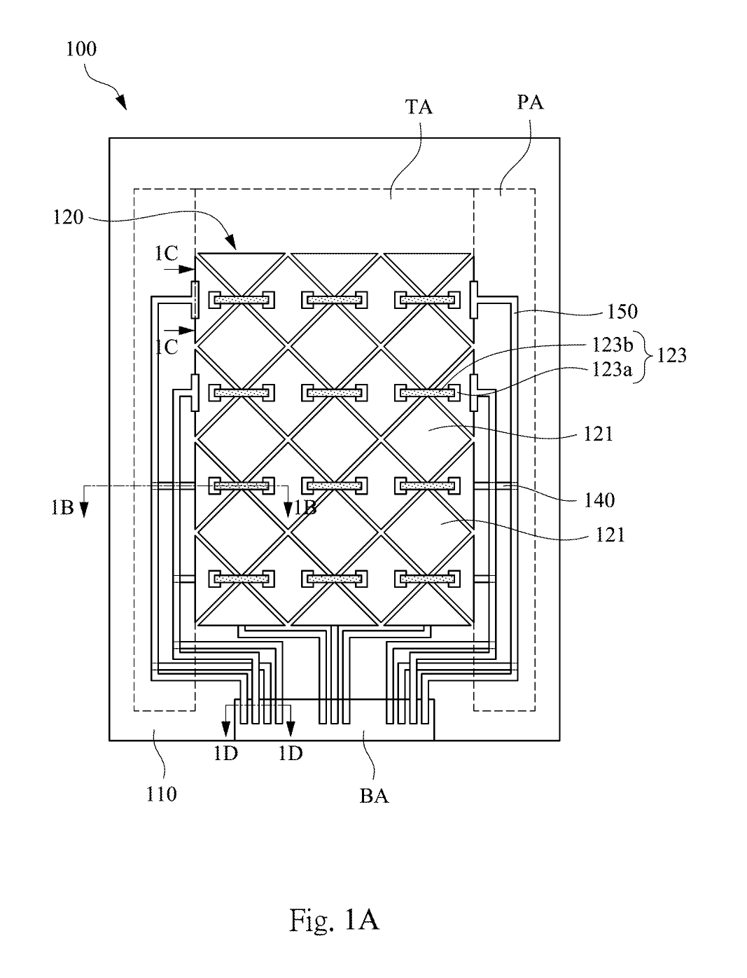

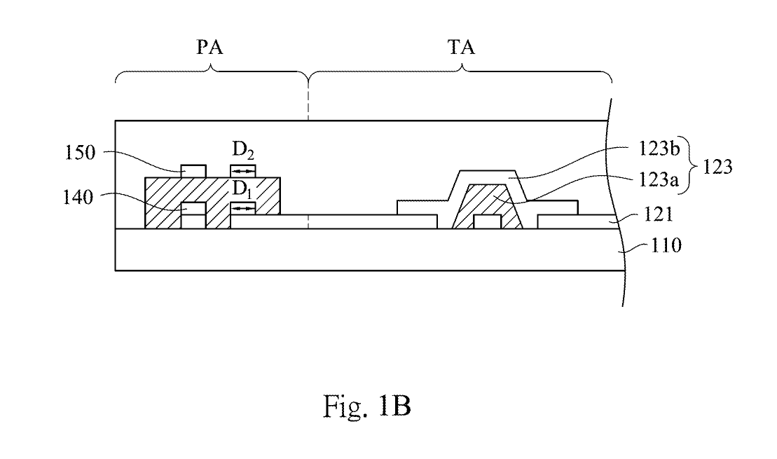

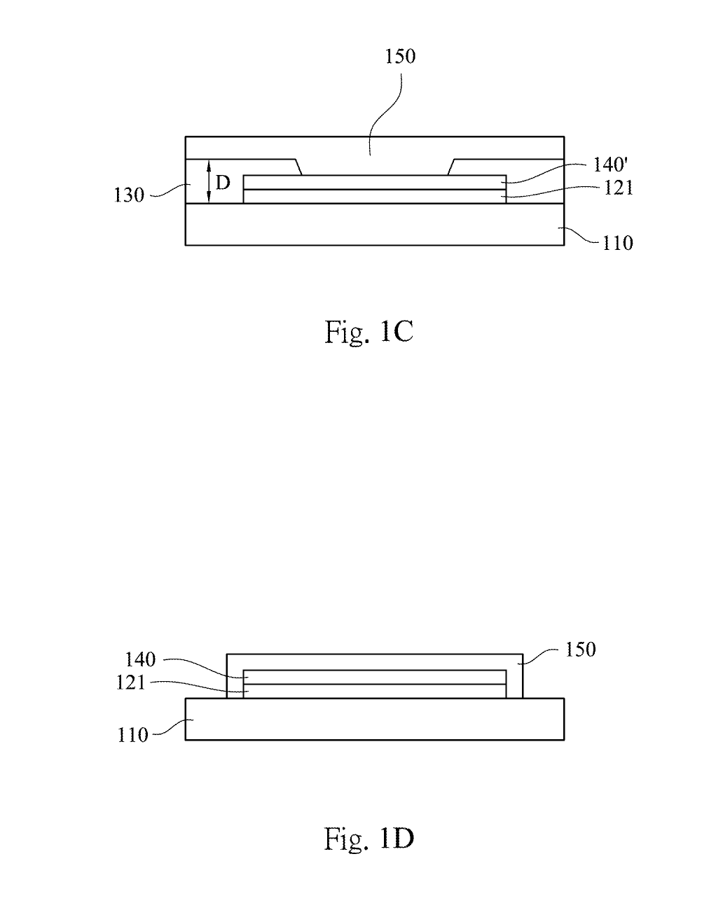

Please refer to FIG. 1A to FIG. 1D. FIG. 1A illustrates a schematic top view of a touch panel 100 according to an embodiment of the present disclosure. FIG. 1B illustrates a cross-sectional view of the touch panel 100 along a line 1B-1B shown in FIG. 1A. FIG. 1C illustrates a cross-sectional view of the touch panel 100 along a line 1C-1C shown in FIG. 1A. FIG. 1D illustrates a cross-sectional view of the touch panel 100 along a line 1D-1D shown in FIG. 1A. As shown in FIG. 1A, the touch panel 100 of the present embodiment has a touch sensing region TA and a peripheral circuit region PA, and the touch panel 100 includes a transparent substrate 110, a touch sensing layer 120, a patterned insulating layer 130, a first fanout circuit 140, and a second fanout circuit 150. For example, in the present embodiment, the transparent substrate 110 may be made of Polyethylene terephthalate (PET), cyclic olefin polymer (COP), polyimide (PI), polyethylene naphthalate (PEN), polycarbonate (PC), or any other flexible plastic materials.

In particular, as the present embodiment shown in FIG. 1A and FIG. 1B, the touch sensing layer 120 is located above the transparent substrate 110, and the touch sensing layer 120 is disposed in the touch sensing region TA, in which the touch sensing layer 120 has plural sensing units 121. For example, in the present embodiment, the sensing units 121 are made of transparent conductive materials such as Indium tin oxide, indium zinc oxide, aluminum tin oxide, aluminum zinc oxide, indium germanium zinc oxide, any appropriate oxide, or a stack of at least two layers of the aforementioned materials. In some embodiments, the first fanout circuit and the second fanout circuit are electrically connected to a first group of the sensing units and a second group of the sensing units respectively.

As the present embodiment shown in FIG. 1A and FIG. 1B, the touch sensing layer 120 also includes at least one bridge structure 123. The bridge structure 123 is connected between two adjacent sensing units 121, in which the at least one bridge structure 123 includes an insulating bump 123a and a connecting line 123b. The connecting line 123b is used to connect the sensing units 121. The insulating bump 123a is disposed between the connecting line 123b and the sensing units 121.

On the other hand, as the embodiment shown in FIG. 1A and FIG. 1B, the first fanout circuit 140 is disposed in the peripheral circuit region PA, and the second fanout circuit 150 is disposed in the peripheral circuit region PA and is located above the first fanout circuit 140. The first fanout circuit 140 and the second fanout circuit 150 is electrically connected to the sensing units 121 respectively, in which a projection of the first fanout circuit 140 on the transparent substrate 110 at least partially overlaps a projection of the second fanout circuit 150 on the transparent substrate 110, and the first fanout circuit 140 and second fanout circuit 150 are insulated from each other. More particularly, as the present embodiment shown in FIG. 1B, the patterned insulating layer 130 is located between the first fanout circuit 140 and the second fanout circuit 150, and in which the first fanout circuit 140 and the second fanout circuit 150 are electrically insulated from each other by the patterned insulating layer 130.

For example, as the embodiment shown in FIG. 1A and FIG. 1B, the first fanout circuit 140 has a first width D1, the second fanout circuit 150 has a second width D2. The projection of the first width D1 of the first fanout circuit 140 on the transparent substrate 110 entirely overlaps a projection of the second width D2 of the second fanout circuit 150 on the transparent substrate 110. In some embodiments, the first width D1 is equal to the second width D2.

As such, by configuring the first fanout circuit 140 and the second fanout circuit 150 on different levels, and making the projection of the first fanout circuit 140 and the projection of the second fanout circuit 150 at least partially overlap with each other on the transparent substrate 110, a width of the peripheral circuit region PA of the touch panel 100 may be reduced, and thus the pursuing for an extreme narrow border is achieved.

On the other hand, as the embodiment shown in FIG. 1C and FIG. 1D, the patterned insulating layer 130 includes plural vias 131. The second fanout circuit 150 is connected to the sensing units 121 through a conductive material 140′ in some of the vias 131 of the patterned insulating layer 130 respectively. And as the embodiment shown in FIG. 1C, the patterned insulating layer 130 is located in the peripheral circuit region PA and bridges the sensing units 121 by the conductive material 140′ in the vias 131. The patterned insulating layer 130 has a thickness D, which is roughly less than 23 um.

On the other hand, as the present embodiment shown in FIG. 1A and FIG. 1D, the touch panel 100 further includes an extending circuit area BA. The first fanout circuit 140 and the second fanout circuit 150 extend to the extending circuit area BA respectively and are connected with peripheral circuit. As the embodiment shown in FIG. 1D, for example, the second fanout circuit 150 is located above the first fanout circuit 140.

For example, in the present embodiment, the first fanout circuit 140 and the sensing units 121 may be formed by performing a lithography etching process on a stack of conductive materials (which at least includes two layers of conductive materials). In addition, as the embodiment shown in FIG. 1C, the conductive material 140′ connecting the second fanout circuit 150 and the sensing units 121 may also be formed by the aforementioned process, that is, patterning the stack of conductive materials with at least two layers of conductive materials. In other words, in the present embodiment, the sensing units 121 in the touch sensing region TA, the first fanout circuit 140 in the peripheral circuit region PA, and the conductive material 140′ are all belonged to a same stack of conductive materials. In the present embodiment, the conductive material 140′ and the first fanout circuit 140 are made of a substantially similar material.

And in the present embodiment, the insulating bump 123a of the touch sensing region TA and the patterned insulating layer 130 of the peripheral circuit region PA are also belong to a same insulating layer, and may be formed by performing a patterning process to a same material. In other words, in the present embodiment, the material of the insulating bump 123a and the material of the patterned insulating layer 130 are substantially the same. In the present embodiment, the insulating bump 123a and the patterned insulating layer 130 may be formed by performing a patterning process on an insulating material layer.

In addition, in the present embodiment, the connecting line 123b in the touch sensing region TA and the second fanout circuit 150 in the peripheral circuit region PA are both belong to a same conductive material layer, and may be formed in a same process. In other words, the material of the connecting line 123b and the material of the second fanout circuit 150 are substantially the same. In the present embodiment, the connecting line 123b and the second fanout circuit 150 may be formed by performing a lithography etching process or a grid printing process on a conductive material layer.

As such, the touch panel 100 may be manufactured by existing processes, there is no need to add additional processes to form the configuration that the first fanout circuit 140 and the second fanout circuit 150 are located on different levels. As such, the projection of the first fanout circuit 140 and the projection of the second fanout circuit 150 partially overlap each other on the transparent substrate 110, so a width of the peripheral circuit region PA may be reduced, and thus the pursuing of the narrow border is achieved.

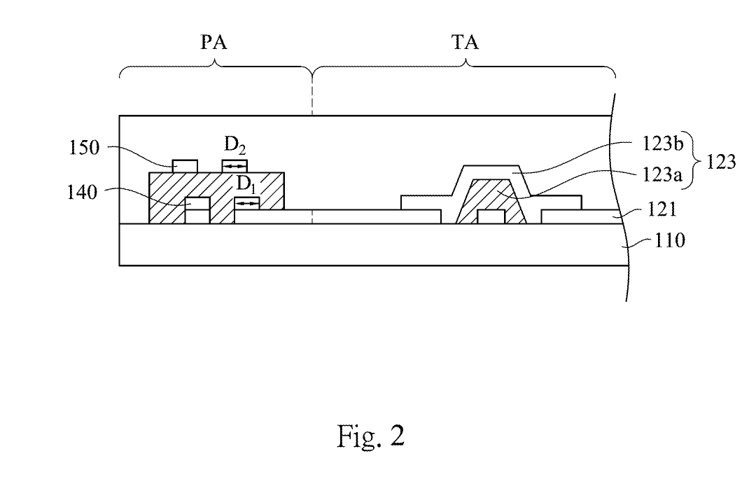

FIG. 2 illustrates a schematic cross-sectional view of a touch panel 200 according to an embodiment of the present disclosure. The touch panel 200 of the present embodiment is similar to the aforementioned touch panel 100 shown in FIG. 1B. The difference between the touch panel 200 and the touch panel 100 is: the projection of the first width D1 of the first fanout circuit 140 of the touch panel 200 on the transparent substrate 110 is shifted from the projection of the second width D2 of the second fanout circuit 150 of the touch panel 200 on the transparent substrate 110, but the projection of the first fanout circuit 140 and the projection of the second fanout circuit 150 at least partially overlap each other on the transparent substrate 110.

As such, as aforementioned, by configuring the first fanout circuit 140 and the second fanout circuit 150 on different levels, and making the projection of the first fanout circuit 140 and the projection of the second fanout circuit 150 partially overlap each other on the transparent substrate 110, the peripheral circuit region PA of the touch panel 200 may be reduced, and thus the pursuing of an extreme narrow border is achieved.

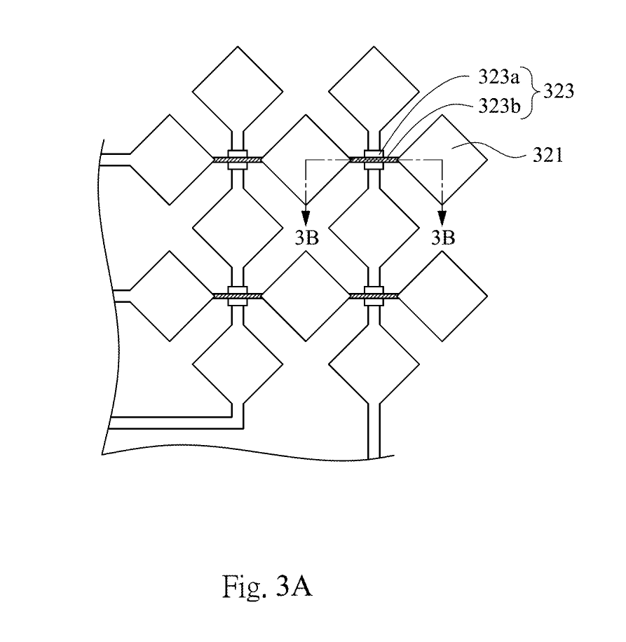

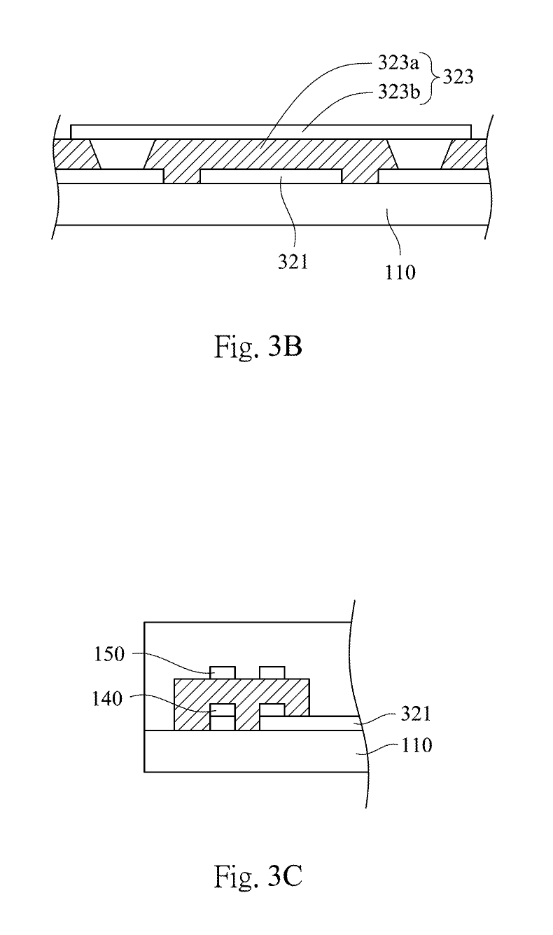

FIG. 3A illustrates a schematic diagram of sensing units 321 of a touch panel 300 according to another embodiment of the present disclosure. FIG. 3B illustrates a cross-sectional view of a touch panel 300 along a line 3B-3B shown in FIG. 3A. FIG. 3C illustrates a cross-sectional view of a peripheral circuit region PA of the touch panel 300. The touch panel 300 is similar to the aforementioned touch panel 100 shown in FIG. 1B. The difference between the touch panel 300 and the touch panel 100 is: as shown in FIG. 3B, in the present embodiment, the connecting line 323b of the bridge structure 323 of the touch panel 300 cross over the insulating bump 323a and electrically connects the two adjacent sensing units 321. However, as the embodiment shown in FIG. 3C, the projection of the first fanout circuit 140 and the projection of the second fanout circuit 150 at least partially overlap each other on the transparent substrate 110.

As such, by configuring the first fanout circuit 140 and the second fanout circuit 150 on different levels, and making the projection of the first fanout circuit 140 and the second fanout circuit 150 at least partially overlap with each other on the transparent substrate 110, a width of the peripheral circuit region PA of the touch panel 300 may be reduced, and thus the pursuing for an extreme narrow border is achieved.

In summary, in the embodiment of the present disclosure, by configuring the first fanout circuit and the second fanout circuit on different levels and making the projection of the first fanout circuit and the projection of the second fanout circuit at least partially overlap each other on the transparent substrate, the width of the peripheral circuit region is reduced, and thus the pursuing of an extreme narrow border is achieved. And the configuration of the touch panel of the present disclosure may be formed by existing processes, such that the first fanout circuit and the second fanout circuit are located on different levels, so there is no need to add additional processes. The quality of the product is improved without increasing manufacturing cost.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A touch panel having a touch sensing region and a peripheral circuit region, the touch panel comprising:
a transparent substrate;
a touch sensing layer located above the transparent substrate and disposed in the touch sensing region, wherein the touch sensing layer has a plurality of sensing units;
a first fanout circuit disposed in the peripheral circuit region; and
a second fanout circuit disposed in the peripheral circuit region and located above the first fanout circuit, wherein the first fanout circuit and the second fanout circuit are electrically connected to the sensing units respectively, wherein a projection of the first fanout circuit on the transparent substrate and a projection of the second fanout circuit on the transparent substrate at least partially overlap each other.

2. The touch panel of claim 1, further comprising:
a patterned insulating layer located between the first fanout circuit and the second fanout circuit, wherein the first fanout circuit and the second fanout circuit are electrically insulated from each other by the patterned insulating layer.

3. The touch panel of claim 2, wherein the patterned insulating layer comprises a plurality of vias, the second fanout circuit is connected to the sensing units through a conductive material in some of the vias of the patterned insulating layer respectively, wherein the conductive material and the first fanout circuit are made of a substantially similar material.

4. The touch panel of claim 3, further comprising:
at least one bridge structure connected between adjacent two of the sensing units, wherein the at least one bridge structure comprises an insulating bump and a connecting line.

5. The touch panel of claim 4, wherein the connecting line crosses over the insulating bump and is electrically connected to the adjacent two of the sensing units.

6. The touch panel of claim 4, wherein the connecting line is electrically connected to the adjacent two of the sensing units through at least an opening of the insulating bump.

7. The touch panel of claim 4, wherein the patterned insulating layer and the insulating bump are made of a substantially similar material.

8. The touch panel of claim 4, wherein the connecting line and the second fanout circuit are made of a substantially similar material.

9. The touch panel of claim 1, wherein the first fanout circuit has a first width, the second fanout circuit has a second width, wherein a projection of the first width of the first fanout circuit on the transparent substrate entirely overlaps a projection of the second width of the second fanout circuit on the transparent substrate.

10. The touch panel of claim 1, wherein the first fanout circuit has a first width, the second fanout circuit has a second width, wherein a projection of the first width of the first fanout circuit on the transparent substrate is partially shifted from a projection of the second width of the second fanout circuit on the transparent substrate.
